(19) United States
(12) Patent Application Publication
(10) Pub. No.: US 2006/0222164 A1
(43) Pub. Date: Oct. 5, 2006

(54) Simultaneous usage of agent and service parameters

(76) Inventors: Saeed Contractor, Pembroke Pines, FL (US); Denny Yang, Arlington, TX (US); Madhusudhana K. Mathur, Miami, FL (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/098,910

(22) Filed: Apr. 4, 2005

(51) Int. Cl. H04M 3/00; H04M 5/00

(52) U.S. Cl. 379/265.05; 379/265.02

(57) ABSTRACT

A system and method for routing a contact to an agent based on a combination of agent parameters and service parameters includes receiving a first contact and determining attributes of the contact. A multi-dimensional agent-service matrix is generated wherein each cell includes at least an agent/service value corresponding to at least a combination of agent and service parameters. The agent parameters may include agent skill level, agent idle time, and order of agents receiving a contact. The service parameters may include wait time of contact in queue, service level goal, number of contacts in queue, and service affinity. A first available agent is identified from the agent-service matrix having a maximum agent/service value and the contact is routed to that agent. Every available agent in the agent-service matrix is available to handle the contact.

### TECHNICAL FIELD

The present invention relates to routing and prioritization of contacts and more particularly, to routing and prioritization systems and methods simultaneously using a combination of service parameters and agent parameters.

### BACKGROUND INFORMATION

Automatic call distribution (ACD) systems are well known. Such systems are typically used to distribute incoming calls among a plurality of agents. The agents are typically broken up into a plurality of groups, where each group is typically handling a specific set of types of calls.

In the past, ACD systems have assigned calls to agents based on, among other factors, the agent skills necessary to handle the call as well as service parameters, such as hold time, idle time, and the like. The known ACD systems divide agents into one or more of a plurality of agent pools. When an ACD system receives a call, the ACD system identifies one or more skills necessary to handle the call. Based on the required skill(s), the ACD system first attempts to place a call to an agent in a first, priority pool of agents exclusively. After a time period, when call waiting time exceeds a predefined threshold, the ACD system expands the agent pool to include agents in a second or more agent pool. For more information, see generally U.S. Pat. No. 6,577,727 to Hymel titled ACD TIER BASED ROUTING.

There are two basic parameters that are often used to assign calls. A first parameter is finding the best agent to take a call from the service when a call arrives. The second parameter is to find the most appropriate call to service when an agent becomes available. While the known ACD systems are generally effective at assigning agents to calls, they suffer from several disadvantages.

One problem is that the known ACD systems try to solve these two parameters independent of each other. When the known ACD system tries to find the best agent to take a call, the ACD system uses the agent parameters to determine the best agent from a pool of agents available for this service. In doing so, the ACD systems overlook calls in other services, that this agent also belongs to, which may have been better suited for this agent because of some service parameters.

Similarly, when choosing the best call to assign to an agent that belongs to multiple services, the known ACD systems use the service parameters. In doing so, the ACD systems overlook other agents in this service who may have become available at the same time as this agent, who may have been better suited for this service's call because of some agent parameters.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

The present invention features a system and method for routing an incoming contact to at least one of a plurality of agents based on a combination of agent parameters and service parameters. The method comprises the acts of receiving a first contact, determining attributes of the first contact, and generating an agent-service matrix. The contact preferably includes telephonic calls, emails, faxes, chat sessions, and Voice over Internet Protocol.

The agent-service matrix includes a first dimension corresponding to an agent and a second dimension corresponding to a service. Each cell within the agent-service matrix includes an agent/service value corresponding to a combination of agent and service parameters. In the preferred embodiment, agent/service values are normalized. The agent parameters include agent skill level, agent idle time, and order of agents receiving a contact. The service parameters include, for example only, wait time of contact in queue, service level goal, number of contacts in queue, and service affinity.

Without regard to a time delay, the method identifies a first available agent from the agent-service matrix having a maximum agent/service value. Every available agent in the agent-service matrix is preferably available to handle the first contact irrespective of the time delay. Once the best-suited agent is identified, the method routes the first contact to the identified first available agent. The agent-service matrix is recalculated each time an agent is added (becomes available) or removed (becomes unavailable).

In an alternative embodiment, the method comprises the acts of receiving the first contact, determining attributes of the first contact, and identifying a list of available agents. At least one service parameter and at least one agent parameter is assigned for each agent in the list of available agents.

An agent-service matrix is next formed wherein the first dimension corresponds to an agent and a second dimension corresponds to a service. Each cell within the agent-service. matrix includes an agent/service value corresponding to a combination of the agent and the service parameters. A first available agent from the agent-service matrix is identified based on a maximum agent/service value. All available agents in the agent-service matrix are considered, preferably irrespective of a time delay. The contact is then assigned to the first available agent.

The present invention also features a system for assigning a first contact to the best-suited agent among a plurality of agents. The system comprises a call vector, an agent-service matrix, and an agent selector. The call vector identifies attributes of the first contact.

The agent-service matrix represents a unique agent/service value for each agent for each of a plurality of services. A first dimension preferably corresponds to the plurality of available agents and a second dimension preferably corresponds to a plurality of services. Each cell within the agent-service matrix includes an agent/service value corresponding to a combination of agent and service parameters.

In the exemplary embodiment, the service parameter weights may include wait time of contact in queue, service level goal, number of contacts in queue, and service affinity. The agent parameter weights may include agent skill level, agent idle time, and order of agents receiving a contact. The agent parameter weights and the service parameter weights are also preferably normalized for the plurality of available agents.

The agent selector identifies an available agent having a maximum agent/service value corresponding to a best-suited service from the list of available agents. All available agents in the agent-service matrix are preferably considered.

### BRIEF DESCRIPTION OF THE DRAWINGS

These and other features and advantages of the present invention will be better understood by reading the following detailed description, taken together with the drawings wherein:

FIG. 1 is a block diagram of an ACD system in accordance with an illustrated embodiment of the present invention;

FIG. 2 is a block diagram illustrative of an agent-service matrix used in the ACD system shown in FIG. 1; and

FIG. 3 is a flow diagram of one embodiment of the method of the ACD system shown in FIG. 1.

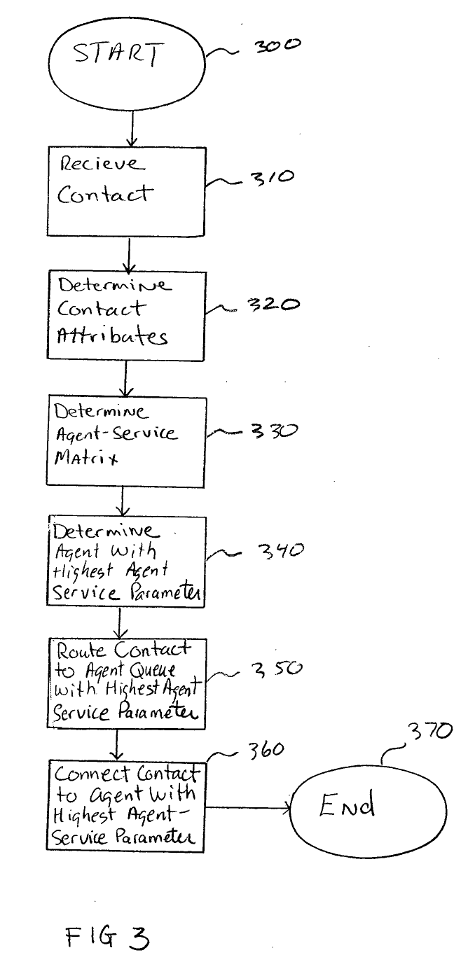

### DETAILED DESCRIPTION OF THE PREFERRED EMBODIMENTS

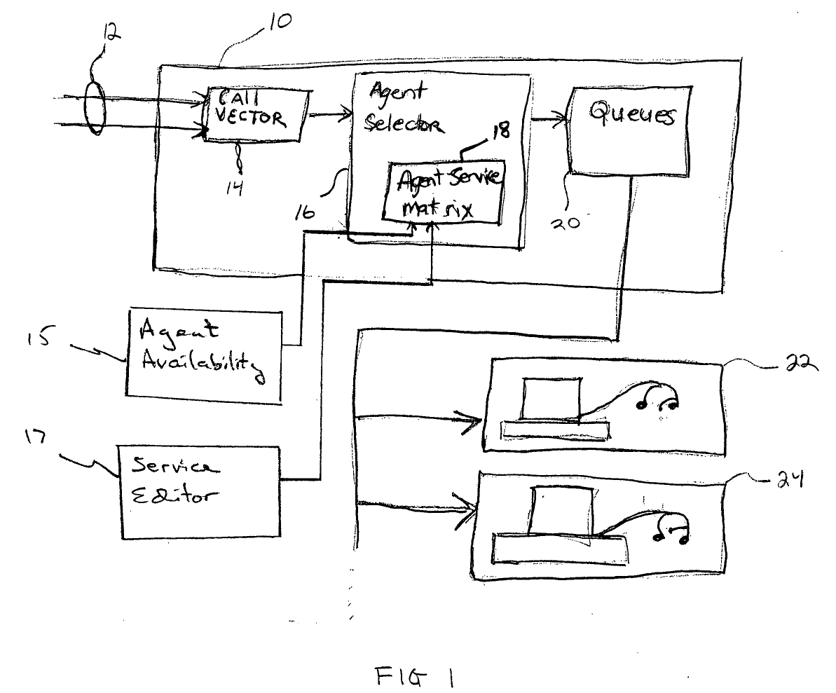

An Automatic call distribution (ACD) 10, FIG. 1, according to one embodiment of the present invention, assigns a contact received over one or more trunk lines 12 and initially identifies one or more agents 22, 24 best suited to handle the contact as will be described in greater detail herein below.

Although the invention will be illustrated below in conjunction with the processing of calls in an exemplary contact center, it is not limited to use with any particular type of contact method, call center or communication processing/contact center. For example, the invention is applicable to the processing of incoming communications, outgoing communications, or both. The disclosed techniques can be used with automatic call distribution (ACD) systems, telemarketing systems, private-branch exchange (PBX) systems, computer-telephony integration (CTI)-based systems, multi-media contact centers, as well as in combinations of these and other types of call centers.

A call center in accordance with the present invention may be configured using any type of network infrastructure, such as, for example, asynchronous transfer mode (ATM), local area networks, wide area networks, Internet Protocol (IP) Networks, etc. The term “call center” as used herein is thus intended to include any type of ACD system, telemarketing system, or other communication system which processes calls, contacts or other service requests, including voice calls, video calls, multimedia calls, e-mail, faxes, text chat or voice messages as well as various portions or combinations of these and other types of communications. The term “call” as used herein is intended to include any of the above-noted types of communications as well as portions or combinations of these and other communications.

As mentioned above, a call generally enters the ACD system 10 over one or more lines 12 (typically trunk lines). The call vector 14 may determine the call attributes from information entered by the customer (for example, but not limited to, information entered into a web page, spoken information, voice recognition, interactive voice response, touch tone recognition, text-to-speech recognition, etc.), ANI (automatic number identification), CLI (call line identification), cookies, scripts, and/or information previously collected about the caller and stored in a database.

The call attributes also include information relevant to how to process the call such as, but not limited to, skills necessary to handle the call. For exemplary purposes only, the relevant call attributes may includes a caller's name, address, language preference, account number/type, product information, and type of membership (e.g., standard, gold, platinum, preferred, etc.).

Once the call attributes have been identified, the call then enters an agent selector module 16. The agent selector module 16, preferably implemented as computer software, identifies one or more agents best suited to handle the call based on several configurable parameters. These parameters can be broadly classified into two categories, agent parameters and service parameters.

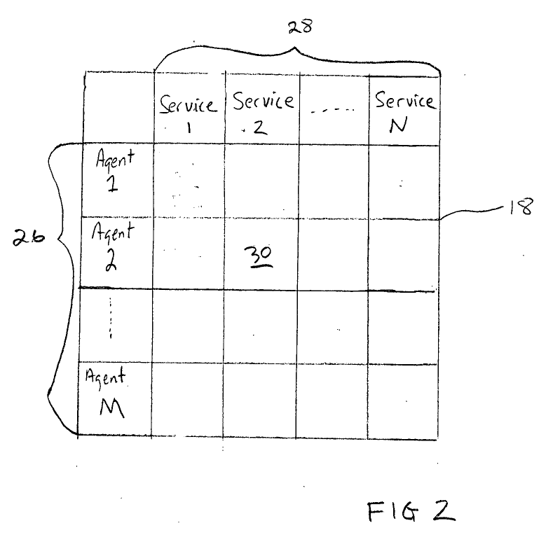

The agent selector module 16 also includes an agent-service matrix 18. Referring specifically to FIG. 2, the agent-service matrix 18 is preferably a two dimensional matrix. A first dimension, preferably disposed along the ordinate 26 of the agent-service matrix 18, preferably represents a plurality of available agents (Agents 1, Agent 2, . . . Agent M) from an agent availability pool indicator 15. Along the abscissa 28 is preferably disposed a plurality of services (Service 1, Service 2, . . . Service N) representing a plurality services or queues/groups. One skilled in the art will readily recognize that the orientation of the matrix may be changed without departing from the invention. One skilled in the art will also recognize that the matrix may be in the form of multiple vectors individually referenced by the agent selector module 16.

It is important to note that the agent-service matrix 18 may include more than two dimensions. While it is possible to have a three or more dimensional matrix, a two dimensional matrix is preferable since it does not involve complicated mathematical operations and is not processor intensive. As will be explained in greater detail herein below, the agent selection calculations will have to be executed over and over again at short time intervals. As a result, it is desirable to minimize the calculations necessary without compromising the agent selection process. Those of ordinary skill in the art, however, will readily understand any modifications necessary to implement the present invention with an agent-service matrix 18 having three of more dimensions.

Each cell 30 within the agent-service matrix 18 represents a unique agent-service grouping. The agent-service groupings include combinations of agent parameters and service parameters. The ACD system's 10 administrator/manager using a service editor 17 assigns different weights to the Service Parameters 28 for each service being run or which can be run on the system, depending on how they want to prioritize the contacts in that service. The Service Parameters 28 may include, but are not limited to, wait time of contact in queue, service level goal, number of contacts in queue, service affinity, calls to agent ratio, relative wait in queue, etc. The ACD system's 10 administrator/manager assigns different weights to the Agent Parameters 26, again depending on how they want to prioritize the contacts.

In the preferred embodiment, the agent parameters 26 and service parameters 28 are each normalized and added together. However, other mathematical methods may be used to normalize or average the agent parameter 26 and service parameter 28 relative to one another.

Once the agent-service matrix 18 has been formed, the agent selector module 16, FIG. 1, compares the call attributes identified by the call vector 14 with the agent-service groupings within the agent-service matrix 18 in order to identify the best-suited agent based on the call attributes. Because each cell 30 represents a combination of both agent parameters 26 and service parameters 28, the agent selector 16 will simultaneously identify an agent having the best possible combination of agent parameters 26 and service parameters 28. This results in the more precise and uniform distribution of contacts amongst the agents, not only based on the needs of the service, but also on the skills of the agents. The process is repeated until there are no more contacts or idle agents in each service.

The agent-service matrix 18 is very flexible and it allows for any number of parameters to be used for prioritization. If there is a need for some services to have a higher static priority and override other parameters, this can be done by assigning a high weight for this parameter.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A method of routing an incoming contact to at least one of a plurality of agents, said method comprising the acts of:
receiving a first contact;
determining attributes of said first contact;
generating an agent-service matrix, said agent-service matrix including:
a first dimension corresponding to agent availability; and
a second dimension corresponding to one or more contact service attributes, wherein each cell within said agent-service matrix includes an agent/service value corresponding to a combination of agent and service parameters;
without regard to a time delay, identifying a first available agent from said agent-service matrix having a maximum agent/service value; and
routing said first contact to said identified first available agent.

2. The method as claimed in claim 1 wherein said agent/service values are normalized.

3. The method as claimed in claim 1 wherein said agent parameters include agent skill level, agent idle time, and order of agents receiving a contact.

4. The method as claimed in claim 1 wherein said service parameters include wait time of contact in queue, service level goal, number of contacts in queue, and service affinity.

5. The method as claimed in claim 1 wherein said agent-service matrix is recalculated each time an agent is added or removed.

6. The method as claimed in claim 1 wherein every available agent in said agent-service matrix is available to handle said first contact irrespective of said time delay.

7. The method as claimed in claim 1 wherein said first contact includes telephonic calls, emails, faxes, chat sessions, and Voice over Internet Protocol.

8. A method of assigning a first contact to at least one of a plurality of agents, said method comprising the acts of:
receiving said first contact;
determining attributes of said first contact;
identifying a list of available agents;
assigning at least one service parameter weight for each agent in said list of available agents;
assigning at least one agent parameter weight for each agent in said list of available agents;
generating one or more agent-service vectors, said agent-service vectors including:
one or more first vectors corresponding to one or more available agents; and
one or more second vectors corresponding to one or more contact service attributes, wherein each cell within the first agent-service vectors and second agent-service vectors includes an agent/service value corresponding to a combination of agent and service parameters;
identifying a first available agent from said first agent-service vectors and second agent-service vectors having a maximum agent/service value, wherein all available agents are considered; and
assigning said first contact to said first available agent.

9. The method as claimed in claim 8 wherein said agent parameter weights are normalized for said list of available agents.

10. The method as claimed in claim 8 wherein said service parameter weights are normalized for said list of available agents.

11. The method as claimed in claim 9 wherein said agent parameter weights include agent skill level, agent idle time, and order of agents receiving a contact.

12. The method as claimed in claim 10 wherein said service parameter weights include wait time of contact in queue, service level goal, number of contacts in queue, and service affinity.

13. The method as claimed in claim 8 wherein said first agent-service vectors and second agent-service vectors are recalculated each time an agent is added or removed.

14. The method as claimed in claim 8 wherein every available agent in said first agent-service vector and second agent-service vector are available to handle said first contact irrespective of a time delay.

15. The method as claimed in claim 8 wherein said first contact includes telephonic calls, emails, faxes, chat sessions, and Voice over Internet Protocol.

16. A system for assigning a contact to an agent, said system comprising:
a contact vector, said call vector identifying attributes of a first contact;
an agent-service matrix representing a unique agent/service value for each agent of a plurality of available agents for each of a plurality of contact service attributes; and
an agent selector, said agent selector identifying an available agent having a maximum agent/service value corresponding to a best suited agent from said list of available agents, wherein all available agents in said agent-service matrix are considered.

17. The system as claimed in claim 16 wherein said agent-service matrix includes
a first dimension corresponding to said plurality of available agents; and
a second dimension corresponding to a plurality of contact service attributes, wherein each cell within said agent-service matrix includes an agent/service value corresponding to a combination of agent and service parameters.

18. The system as claimed in claim 17 wherein said agent parameter weights and said service parameter weights are normalized for said plurality of available agents.

19. The system as claimed in claim 18 wherein said service parameter weights include wait time of contact in queue, service level goal, number of contacts in queue, and service affinity and wherein said agent parameter weights include agent skill level, agent idle time, and order of agents receiving a contact.

20. The system as claimed in claim 18 wherein every available agent in said agent-service matrix is available to handle said first contact irrespective of a time delay.
